(19) United States
(12) Patent Application Publication
(10) Pub. No.: US 2007/0268817 A1
(43) Pub. Date: Nov. 22, 2007

(54) Method and system for protecting a sub-domain within a broadcast domain

(75) Inventors: Gerald Smallegange, Sittsville (CA); Dinesh Mohan, Kanata (CA); Marc Holness, Ottawa (CA); Martin Charbonneau, Quebec (CA); Donald Ellis, Ottawa (CA); Adrian Bashford, Ottawa (CA)

Correspondence Address: CHRISTOPHER & WEISBERG, P.A., 200 EAST LAS OLAS BOULEVARD, SUITE 2040, FORT LAUDERDALE, FL, 33301, US

(73) Assignee: Nortel Networks Limited

(21) Appl. No.: 11/546,170

(22) Filed: Oct. 11, 2006

Related U.S. Application Data
(60) Provisional application No. 60/802,336, filed on May 22, 2006.

(51) Int. Cl. H04J 1/16; H04L 12/26

(52) U.S. Cl. 370/216; 370/241

(57) ABSTRACT

A method and system for protecting a service available on a broadcast domain. A sub-domain is established within the broadcast domain. The sub-domain includes a group of nodes used to provide a communication path to the service. A primary sub-domain maintenance association and a back-up sub-domain maintenance association are monitored. The primary and sub-domain maintenance associations are a set of primary and back-up paths, respectively, representing connectivity between nodes acting as edge nodes in the sub-domain. A fault is detected within the primary sub-domain maintenance association and a switch to the back-up sub-domain maintenance association occurs.

### CROSS REFERENCE TO RELATED APPLICATION

This application is related to and claims priority to U.S. Provisional Patent Application No. 60,802,336, entitled SUB-DOMAIN PROTECTION WITHIN A BROADCAST DOMAIN, filed May 22, 2006, the entire contents of which is incorporated herein by reference.

### STATEMENT REGARDING FEDERALLY SPONSORED RESEARCH OR DEVELOPMENT

n/a

### FIELD OF THE INVENTION

The present invention relates to network communications, and in particular to a method and system for protecting point-to-point and multi-point connections that form a network sub-domain that is part of a broadcast domain such as may be found in Internet Protocol (“IP”) based communication networks.

### BACKGROUND OF THE INVENTION

The proliferation of network-based communications, such as those using the transmission control protocol/internet protocol (“TCP/IP”), has created an environment in which the sharing of physical resources by service providers to accommodate different customers has become commonplace. For example, service providers offer virtual local area network (“VLAN”) services in which logical layer connections and communications are separate for each customer, even though these customers share the actual physical layer communications, e.g., Ethernet switching hardware, cables, etc.

A broadcast domain is an area of a network reachable through the transmission of a frame that is being broadcast. As such, with respect to VLANs, frames that are broadcast, such as frames with a destination of unknown unicast address, broadcast or multicast, are sent to and received by devices within the VLAN (or LAN), but not by devices on other VLANs or LANs, even though they are part of the same physical network. Accordingly, LANs and multi-point VLANs are examples of “broadcast domains”. A broadcast domain can be an area within a multi-point Ethernet network where frames with a destination of unknown unicast, broadcast or multicast are broadcasted.

Institute of Electrical and Electronics Engineers (“IEEE”) 802.1Q standard amendments, such as the 802.1ad and 802.1ah standards establish parameters for backbone packet-based bridging networks. While management and administrative responsibilities of a large scale service provider network may be physically demarcated to allow for a regional approach to managing the physical infrastructure, such is not the case from the point of view of the services being deployed. As such, these standards do not establish a method for providing back-up protection from the service point of view to anything smaller than at the broadcast domain level. The result is inefficient back-up provisioning due to the inability to monitor and manage service availability at a more granular level than a broadcast domain.

For example, although proposals for providing back-up protection large scale networks such as large Ethernet networks include split multi-link trunking (“SMLT”) and link aggregation, these proposals have not met the needs of service providers because they are not deterministic, having been developed to meet the requirements of their original application, namely enterprise networks.

What is desired is a deterministic arrangement under which a broadcast domain can be sub-divided based, for example, on multiple unique VLAN topologies that provide common service end points. The service referred to here can mean both the end-to-end service that is being offered to the user of the provider networks and the facilities being used by the provider to offer end-to-end services. It is further desired that the arrangement provides that one of these unique VLAN topologies be used as the primary path for end-to-end service data, referred to herein as “traffic”, with one or more unique VLAN topologies used for traffic in the event that the primary path is less suitable for providing the desired service(s). It is also desired to have an arrangement that provides rapid switching of services between these VLANs in the event of a failure in a manner that is transparent to devices outside a sub-domain.

### SUMMARY OF THE INVENTION

The present invention advantageously provides a method and system for protecting services available across a broadcast domain. A primary and at least one back-up sub-domain are established within the broadcast domain, backing up access to services at a sub-domain level through the establishment and monitoring of sub-domain maintenance associations (“SDMAs”). SDMAs are the set of point-to-point connections/paths, e.g., media access control (“MAC”) layer source destination, representing connectivity between edge nodes of a sub-domain, and are established for both primary and back-up sub-domains within a maintenance domain. An edge node of a sub-domain can be an edge node or a core node of a broadcast domain. Each sub-domain protection group (“SDPG”) has a primary and back-up SDMA and provides the logical switching mechanism to cause the nodes to switch the packet routing from the primary SDMA to the back-up SDMA when a failure occurs on a link on a path or a node on a path within the primary SDMA.

In accordance with one aspect, the present invention provides a method for protecting a service available on a broadcast domain. A sub-domain is established within the broadcast domain. The sub-domain includes a group of nodes used to provide a communication path to the service. A primary sub-domain maintenance association and a back-up sub-domain maintenance association are monitored. The primary and back-up sub-domain maintenance associations are a set of primary and back-up paths, respectively, representing connectivity between nodes acting as edge nodes in the sub-domain. A fault is detected within the primary sub-domain maintenance association and a switch to the back-up sub-domain maintenance association occurs.

In accordance with another aspect, the present invention provides a storage medium storing a computer program which when executed performs a method for protecting a service available on a broadcast domain in which a sub-domain is established within the broadcast domain. The sub-domain includes a group of nodes used to provide a communication path to the service. A primary sub-domain maintenance association and a back-up sub-domain maintenance association are monitored. The primary and back-up sub-domain maintenance associations are a set of primary and back-up paths, respectively, representing connectivity between nodes acting as edge nodes in the sub-domain. A fault is detected within the primary sub-domain maintenance association and a switch to the back-up sub-domain maintenance association occurs.

In accordance with still another aspect, the present invention provides a system for providing a service available on a broadcast domain. A plurality of nodes are arranged as a sub-domain which provide a communication path to the service. Each of the nodes has a storage device and a central processing unit. The storage device stores data corresponding to a primary sub-domain maintenance association and a back-up sub-domain maintenance association. The primary and back-up sub-domain maintenance associations are a set of primary and back-up paths, respectively, representing connectivity between nodes acting as edge nodes in the sub-domain. The central processing unit operates to detect a fault within the primary sub-domain maintenance association and switch to the back-up sub-domain maintenance association.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a system constructed in accordance with the principles of the present invention;

FIG. 2 is a block diagram of a sub-domain constructed in accordance with the principles of the present invention;

FIG. 3 is a chart showing relationships within a sub-domain maintenance association;

FIG. 4 is a chart showing an exemplary sub-domain maintenance association state machine; and

FIG. 5 is a chart showing exemplary sub-domain maintenance association scenarios for a sub-domain protection group.

### DETAILED DESCRIPTION OF THE INVENTION

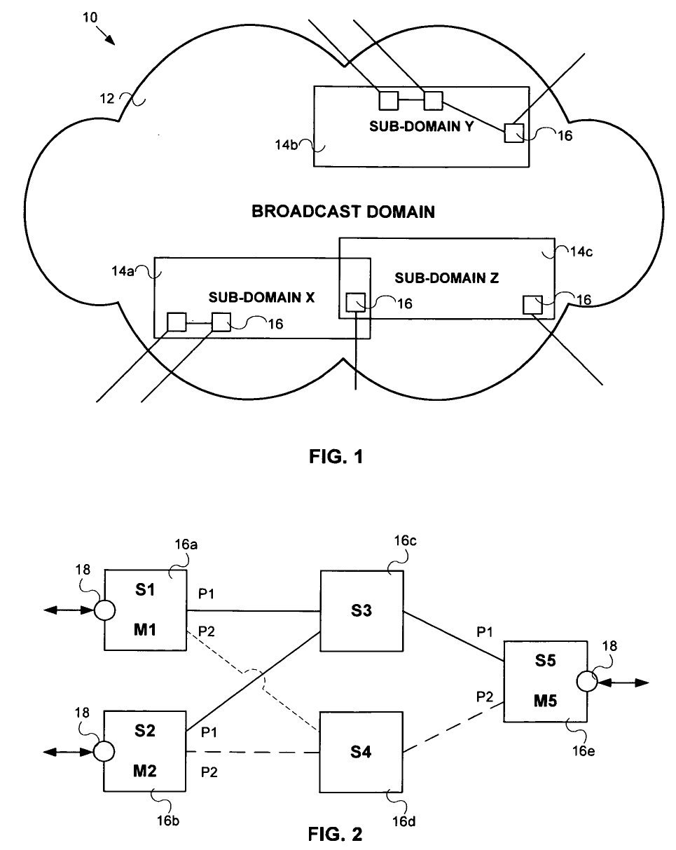

Referring now to the drawing figures in which like reference designators refer to like elements, there is shown in FIG. 1 a block diagram of a system constructed in accordance with the present invention and designated generally as “10”. System 10 includes broadcast domain 12. Broadcast domain 12 includes one or more sub-domains, for example, sub-domain X 14a, sub-domain Y 14b, and sub-domain Z 14c (referred to collectively herein as sub-domain 14). Sub-domains 14 each define a sub-domain.

A sub-domain is a subset of the nodes that are part of a broadcast domain. Nodes in a sub-domain are the set of nodes that provide transport of a service instance or a number of service instances through the network, e.g., an Ethernet network. In other words, a sub-domain is a portion (or all of) a broadcast domain that is based on services using that portion of the broadcast domain. As is used herein, the term “service” applies to end-to-end connectivity, where connectivity can be point-to-point, multi-point and point-to-multi-point, being offered to user of the broadcast domain or facilities, e.g. trunks, used within the broadcast domain to carry traffic related to end-to-end connectivity in whole or in-part.

As is used herein, the term “domain” is an infrastructure having multi-point connectivity which can be used to offer point-to-point, multi-point and point-to-multi-point connectivity services, should such be required based on system design needs. As one aspect of the invention, sub-domains may be subsets of nodes that are part of a broadcast domain but not necessarily physically contiguous. In other words, there can be a logical relationship between the group of nodes such that access to a service is self-contained within the sub-domain regardless of physical connectivity. As another aspect of the invention sub-domains may be a subset of nodes that are part of a broadcast domain that are physically contiguous within a switching environment. In other words, there can be a physical relationship between the group of nodes such that access to a service is not-necessarily self contained within the sub-domain.

Each sub-domain includes a group of nodes 16 which define a path between edge nodes within a sub-domain 14. Of note, it is possible that a node 16 is part of multiple sub-domains 14 depending upon the services supported between edge nodes and the need for a particular node 16 to support different services. For example, it is possible that a node 16 can support two separate services that share a common end point or port but are associated with and protected by different sub-domains.

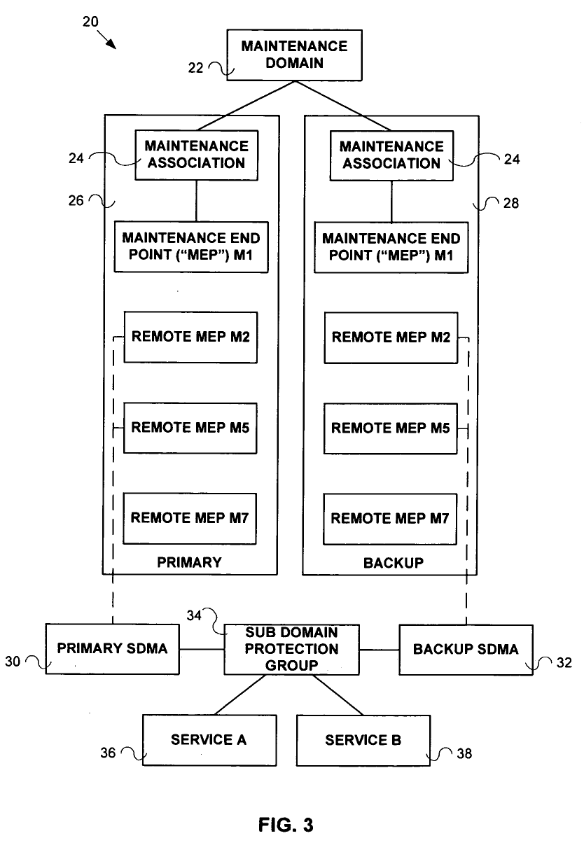

An exemplary sub-domain 14 is shown and described with reference to FIG. 2. The sub-domain 14 shown in FIG. 2 includes nodes S1 16a, S2 16b, S3 16c, S4 16d, and S5 16e. Nodes S1 16a, S2, 16b and S5 16e are edge nodes having user to network interfaces (“UNI”) 18 and network communication ports P1 and P2, corresponding to a service which is self-contained within the sub-domain. It is also contemplated that one or more nodes 16 can be edge nodes of a sub-domain that provide network to network interfaces (“NNI”) for the same service instance (not shown). It is also contemplated that, as another example, a sub-domain, may include nodes 16 which do not have any UNI 18 interfaces and only provide network to NNI interfaces for one or more service instances (not shown). The physical composition of a node 16 can be a network communication switch or any other networking device suitable for implementing the functions described herein. Nodes 16 include a suitable central processing unit, volatile and non-volatile storage memory and interfaces arranged to perform the functions described herein.

End-to-end services are supported by connecting customer devices (or customer networks themselves) to an edge node via UNI 18 which is the same as a UNI on the broadcast domain. A sub-domain protects a service or a group of service instances. A node 16 that serves as a service end node, within the sub-domain, is also designated by an “M” prefix. FIG. 2 shows a primary sub-domain, indicated by the solid lines connecting nodes 16 and a backup sub-domain indicated by the dashed lines connecting nodes 16. For example, the primary path between nodes S1 16a and S5 16e is via node S3 16c, while the backup path between nodes S1 16a and S5 16e is via node S4 16d.

A sub-domain maintenance association (“SDMA”) is defined as a set of paths that represents the connectivity between edge nodes, e.g., nodes S1 16a and S5 16e, within a sub-domain 14. The state of a path to a remote node in a sub-domain is represented by a remote maintenance association end point (“RMEP”) state. This RMEP is a more specific instance of the MEP as defined by ITU-T Y.1731 and IEEE 802.1ag, corresponding to a MEP that is logically not collocated with the device for which the SDMA is being populated. The state of the SDMA is derived by the collective states of the RMEPs associated with an SDMA at each node. Of course, it is understood that an RMEP can be associated with multiple SDMAs. This is the case because, as discussed above, sub-domains can overlap, i.e., share the same nodes and/or end points. It is also noted that an SDMA can include a subset of the RMEPs monitored by a maintenance association (“MA”).

Having defined the set of paths that represents the connectivity between edge nodes 16 within a sub-domain 14, the protections and groupings used to provide backup protection for services available on the network can be defined and explained. Groupings established within a sub-domain to protect access to services are defined within a sub-domain protection group (“SDPG”). The nodes comprising an exemplary SDPG is shown in FIG. 2 and is explained with reference to FIG. 3. Sub-domain protection relationship table 20 is part of a SDPG configured with primary and backup SDMAs. However, services are associated with the SDPG itself. For example, a service instance for a provider backbone bridge network is a service identifier (“SID”). The SDPG provides the switching mechanism between the primary and backup SDMAs when a failure occurs on a link or a node within an SDMA.

A SDPG can be represented by a table such as table 20 and represents the protection group relationships with respect to a node, for example, node S1 16a. Other nodes have their own tables and data structures. Within a maintenance domain 22, maintenance associations 24 are established with respect to the primary and backup sub-domains 26 and 28, respectively. Maintenance end points refer to nodes 16 at the end of a path within the sub-domain (“MEP”). Referring to FIG. 2, MEPs M1, M2 and M5 are designated and correspond to nodes S1 16a, S2 16b, and S5 16e, respectively, by virtue of their position as end points within the depicted example sub-domain 14. It is possible that node S3 16c could serve as a maintenance end point for a different, and not depicted, sub-domain.

Sub-domain protection relationship 20 is shown with respect to MEP M1. It is understood that other sub-domain relationships 20 can be constructed for the other MEPs in the sub-domain, e.g., a sub-domain protection relationship for MEP M5. Sub-domain protection relationship 20 for MEP M1 for the primary sub-domain 26 includes RMEPs M2, M5, and M7. As is seen with respect to FIG. 2, RMEP M2 corresponds to S2 16b and RMEP M5 refers to node S5 16e. Accordingly, each RMEP that is reachable and associated with the SDMA is provided in sub-domain protection relationship table 20. Table 20 is stored in the corresponding node, in this case, node S1 16a. Of note, RMEP M7 is shown in primary sub-domain 26 and backup sub-domain 28. RMEP M7 is part of the overall maintenance association 24, but is not defined as part of the sub-domain depicted in FIGS. 2 and 3. The RMEP and MEP definitions refer to remote sites and the current node being considered respectively, as is set out in ITU-t Y.1731 and IEEE 802.1ag.

For FIG. 3, the SDPG provides the switching mechanism between primary and back-up SDMAs when a failure occurs on a point-to-point path within an SDMA. As is shown in FIG. 3, both primary SDMA 30 and back-up SDMA 32 (each associated with RMEPs M2, M5 and M7) are associated with sub-domain protection group 34. Sub-domain protection group 34 itself protects and provides access to services A 36 and B 38. The mechanism for switching between and monitoring and switching between primary sub-domain 26 and backup sub-domain 28 to provide access to services A36 and B38 is described below in detail. Of note, although only two services are shown in FIG. 3, it is understood that any quantity of services can be supported within an SDPG. Similarly, subject to the processing and storage limitations on a node 16, any quantity of RMEPs can be associated with a particular sub-domain protection group as well.

Advantageously, according to one embodiment of the invention, no new MEPs are needed for sub-domain protection with respect to MEPs defined in existing standards. Such is the case because sub-domain MEPs are a subset of domain MEPs needed for monitoring the infrastructure facilities in the broadcast domain as a whole. The choice of an SDMA and the corresponding subset of domain MEPs is based on the need to provide protection to a specific subset of services among the entire set of services being carried and supported across the infrastructure facility in the broadcast domain within the service providers' network. As is shown in FIG. 3, the MEPs associated with an SDMA are located at the same end points of the infrastructure facilities, e.g., node S1 16a, where the relevant services and their corresponding communications ingress and egress.

According to another embodiment of the invention, new MEPs are created for sub-domain protection which are same as MEPs defined in existing standards. Such is the case because sub-domain MEPs are used in a manner independent to domain MEPs needed for monitoring the infrastructure facilities in the broadcast domain as a whole. The SDMA MEPs are located at the edge nodes of the sub-domain to provide protection to a specific subset of services among the entire set of services being carried and supported across the infrastructure facility in the broadcast domain within the service providers' network. Some or all of these SDMA MEPs may share same end points of the domain MEPs, when the edge node 16 supports a UNI 18, where the relevant services and their corresponding communications ingress and egress. When the SDMA MEPs are positioned across edge node 16 that does not support UNI 18 but only a NNI, the end points are not shared with domain MEPs. According to this embodiment of the invention, the SDMA monitoring is carried out by SDMA MEPs at a rate higher than the rate of monitoring the domain wide maintenance association using domain MEPs.

As is discussed below in detail, faults within a sub-domain 14 are detected at a MEP designated in FIG. 3 by node having an “M” prefix by monitoring the condition of specific remote MEPs using circuit supervision messages (such as continuity check messages or “CCMs”). CCMs are defined by both the International Telecommunications Union (“ITU”) and the IEEE, and are not explained in detail herein. Note that a CCM is a specific instance of a circuit supervision message and its use herein is intended to be synonymous with the broader term “circuit supervision message”. Of note, a MEP can depict the loss of communication with an RMEP using unicast/multicast CCM. However, a MEP cannot detect a specific RMEP that might be detecting faults by using multicast CCM. Such is the case because the remote defect identification (“RDI”) received does not communicate the specific RMEP that is contributing to the fault but only that a RMEP has detected a fault. However, it is possible to determine if the RMEP is experiencing a problem communicating with the local MEP if unicast CCMs are used.

With respect to monitoring both the primary and backup SDMAs, e.g., SDMA corresponding to primary sub-domain 26 and backup sub-domain 28. The actual SDMA states defined in connection with the present invention are discussed in detail below. In general, upon detection of a fault in the primary SDMA, a switching decision can be made to switch the corresponding services to backup connectivity to the sub-domain. The switching decision is also dependent on the state of the backup SDMA because there is little sense in switching to the backup SDMA if there is a problem with the backup, such as a network or node outage and the like. Of course, it is contemplated that a reversion scheme is also used such that when protection switching is made to the backup SDMA due to failure of the primary SDMA, primary connectivity is restored when the primary SDMA is again available. However, such reversion schemes are outside the scope of the present invention and any available reversion scheme can be applied.

In order to affect switching from the primary sub-domain to the backup sub-domain, knowledge of the RMEP and SDMA states must be maintained by nodes in the sub-domain. Initially, nodes, e.g., node S1 16a, are arranged to have a MEP created to send periodic unicast CCMs. In operation, a periodic unicast CCM is sent from each node to each remote node in the sub-domain. For example, with respect to node S1 16a, that node sends a periodic unicast CCM to M2 and M5 (nodes S2 16b and S5 16e, respectively). Such is also the case with respect to VLANs. If a remote node is coming to multiple sub-domains on a particular origination node, a single CCM message is sent for all SDMAs that are associated with the remote node.

The state of each RMEP is determined. The state of the RMEP on each node is determined by receipt of CCMs sent from other nodes. If a predetermined number of CCMs are not received within a specified period, the RMEP is considered to be down and is moved to a failed state. If RMEP failure is detected, a remote defect identification (“RDI”) message is sent in the unicast message destined to the remote note associated with the failed RMEP to signal failure detection, thereby ensuring that unidirectional failures and other failures are detected at both endpoints of a path within a sub-domain.

The SDMA state represents the collective states of the RMEPs that are associated with the SDMA within a node. For example, referring to FIG. 3, node S1 16a maintains the states of RMEPs M2, M5 and M7. The state of maintenance association 24 with respect to the primary sub-domain 26 is maintained in node S1 16a within that node. As such, if a failure is detected, the table stored in S1 16a would indicate the failure of RMEP M5 or at least the inability to communicate to RMEP M5 so that a determination can be made as to whether to move communications to the backup sub-domain.

The present invention defines a number of SDMA states. The “IS” state means the SDMA is administratively in service and available to other nodes 16 within the sub-domain, i.e. RMEPs, are capable of providing complete service. The “IS-ANR” state means the SDMA is administratively in service but some paths to other nodes within the sub-domain, i.e. RMEPs, are not capable of providing complete service. In other words, one or more RMEPs within the SDMA are out of service (“OOS”). Such can be detected by using the ITU-T Y.1731 and IEEE 802.1ag protocols.

The “OOS-AU” state means the SDMA is administratively in service, but paths to other nodes within the sub-domain, i.e. RMEPs, are not capable of providing complete service. In other words, all RMEPs within the SDMA are out of service such as may be detected using IEEE 802.1 ag. The “OOS-MA” state means the SDMA is administratively out of service and all paths to other nodes within the sub-domain are capable of providing complete service. In other words, all RMEPs are in service, but the SDMA is administratively out of service. The “OOS-MAANR” state means the SDMA is administratively out of service, but only some paths to other nodes within the sub-domain are not capable of providing complete service. In other words, one or more RMEPs within the SDMA are out of service such as may be detected by the ITU-T Y.1731 and the IEEE. 802.1ag protocols. Finally, the “OOS-AUMA” state means the SDMA is administratively out of service and all paths to other nodes within the sub-domain are not capable of providing complete service. In other words, all RMEPs within the SDMA are out of service as may be detected using the ITU-T Y.1731 and the IEEE. 802.1ag protocols.

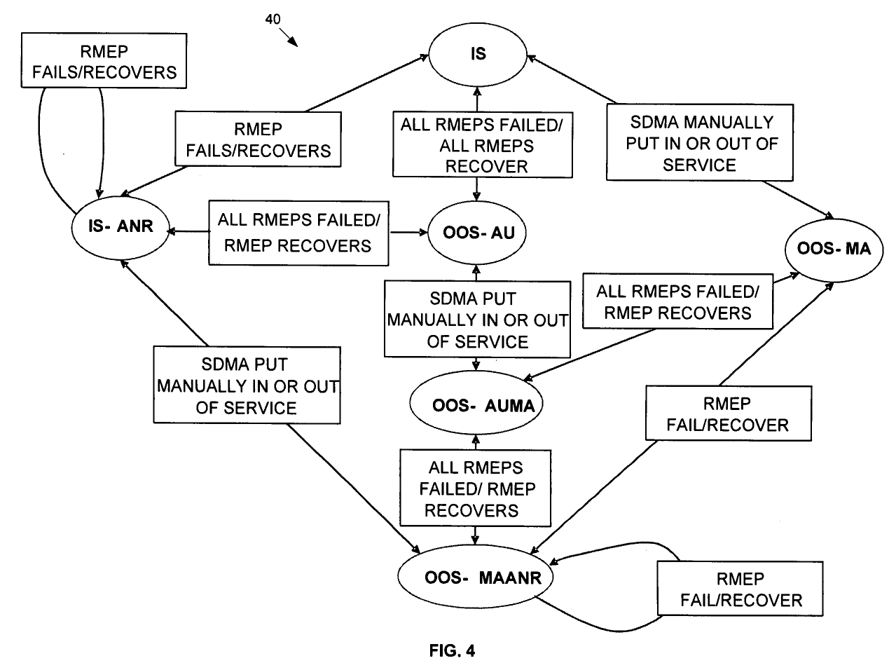

Using these states, an SDMA can move from state to state. For example, an SDMA in the “IS” state can move to an “OOS-AU” state if all RMEPs are detected as failed. Similarly, a situation where all RMEPs have failed but have recovered can cause the SDMA state to move from “OOS-AU” to the “IS.” Accordingly, a state table can be created showing a state of sub-domain, an example is shown as state machine 40 in FIG. 4.

The RMEP state and the information used to determine whether the state of an RMEP has changed can be accomplished by monitoring for the receipt of CCMs from the RMEP and can be implemented programmatically in a corresponding node 16. For example, the expiration of a predetermined time interval can be used to trigger an indication that an RMEP has failed and no CCM is received. Similarly, a shorter threshold time period can be used to indicate the degradation in performance of communication with an RMEP perhaps indicating a problem. For example, a predetermined time period can be established such that failure to receive a CCM within three time intervals may indicate failure while receipt of a CCM between two and three time intervals may be used to indicate degraded communication performance within respect to the RMEP. Based on the detection of an RMEP failure event, the state of the SDMA state machine can be updated if the failure necessitates a state change. CCMs are sent on a per destination endpoint within the broadcast domain which could be defined by a VLAN.

As another option for maintaining RMEP and SDMA states, multicast CCMs with unicast CCMs can be used with remote defect identification (“RDI”) to indicate failed formats. In this case, a periodic multicast CCM is sent from each node for receipt by all other MEPs. As with the unicast CCM option discussed above, multicast CCMs are sent per VLAN such that if a remote node is common to multiple sub-domains that share a VLAN (BTAG), only one CCM is periodically sent to the VLAN. As with the unicast CCM option, the RMEP state is determined by receipt of the CCM sent from other nodes. If an RMEP failure is detected, the unicast CCM indicating RDI is also sent periodically to the remote node associated with the RMEP to signal failure detection, thereby ensuring that unidirectional failures and other failures are detected at both endpoints of a path within a sub-domain. For this mode, CCMs are sent on a per source MEP and multicasted to all RMEPs within the broadcast domain. The broadcast domain would generally be defined by a VLAN. In other words, multicast CCMs are sent by each MEP. If an RMEP is suspected of having failed, the MEP that detects the failure also sends unicast CCMs indicating RDI to the particular suspect RMEP.

As still another option, the RMEP and SDMA states can be maintained using multicast CCMs with RMEP failure indication via the multicast CCM as well as the use of RDI and the maintenance of a failed remote MEP list. In this case, a MEP is created to send periodic multicast CCM messages as both the previously described option. Similarly, multicast CCMs are sent on a per-VLAN level. The state of RMEPs on each node is determined by the receipt of CCMs sent from other nodes. If a predetermined number of messages are not received within a specified period, the RMEP is moved to a failed state. If RMEP failure is detected, the multicast CCM message includes RDI as well as a list of RMEPs that have been detected as failed. This information can be used by the other remote nodes to update their state tables.

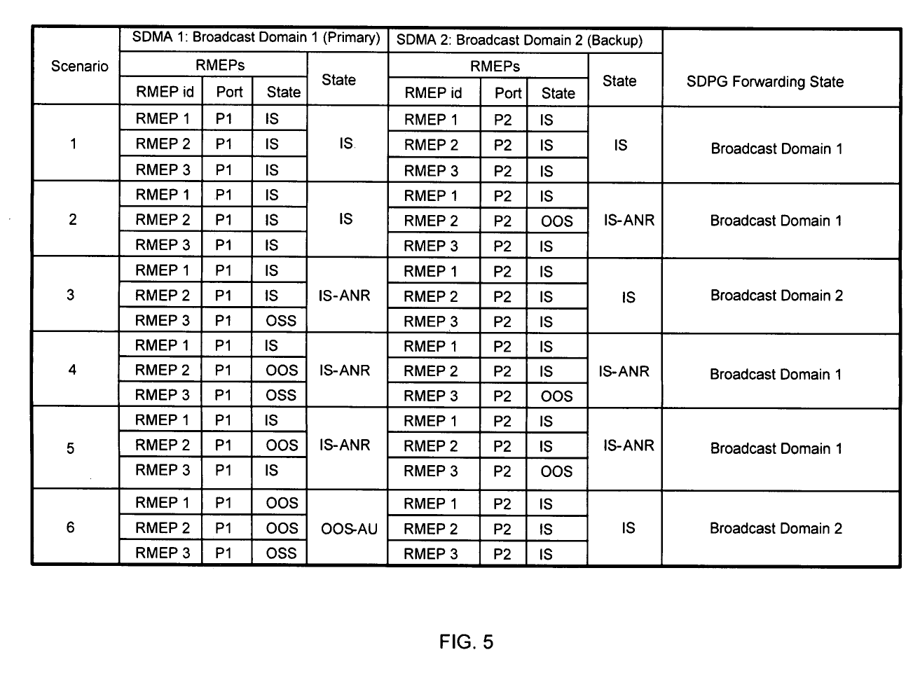

Of course, the purpose of the CCM updates and state changes is to allow the switching of a portion of a broadcast domain, i.e. the sub-domain, from the primary sub-domain to the backup sub-domain and vice versa to keep the services and access to the services up and running. FIG. 5 shows exemplary scenarios for a provider backbone network having an SDMA for the primary sub-domain “broadcast domain 1” and a second SDMA for the backup sub-domain “broadcast domain 2.” The example shown in FIG. 5 assumes three RMEPs. As such, in the example shown in scenario 1, both the primary and backup SDMAs are in service, so the SDPG forwarding state shows use of broadcast domain 1, i.e., the primary sub-domain. Scenario 2 shows an example where an RMEP on the backup sub-domain, namely RMEP 2, is out of service. Accordingly, the state of the backup sub-domain is set to “IS-ANR” and the forwarding state remains with the primary sub-domain. In contrast, scenario 3 shows an out of service condition for RMEP 3 in the primary sub-domain such that the state of the primary sub-domain is set as “IS-ANR.” In this case, the SDPG forwarding state is set to use the backup sub-domain because RMEP 3 is in service using the backup sub-domain.

Scenario 4 shows a condition where both the primary and backup SDMAs have failures. In this case, the SDPG forwarding state remains with broadcast domain 1 since there are failures regardless of which SDMA is used. However, it is also contemplated that the SDPG forwarding state can be set to use the SDMA with the fewest amounts of failures. In the case of scenario 4, this would mean using the backup SDMA as it only has a single failure, namely that of RMEP 3.

Scenario 6 shows an out of service condition for RMEPs in the primary SDMA. In this case, the SDPG forwarding state is set t use the backup SDMA. Of course, the scenarios shown in FIG. 5 are merely examples, as the quantity of RMEPs and the possible failure scenarios are much larger than the depicted example.

Using the above explanation, it is evident that switching is based on the sub-domain of interest. For example, as discussed above, it is possible that a particular node 16 can participate in more than one sub-domain 14. Accordingly, a failure on that node or a failure of a link to that node may implicate and necessitate a change to back-up sub-domains for more than one sub-domain. This may in turn affect availability of more than one service. Similarly, it is possible that failure of a particular node 16 or link to a node 16 may not impact services within a sub-domain. Accordingly, switching from the primary to the back-up SDMA is only undertaken if some piece within the sub-domain is detecting as having a fault. Such may be explained by reference to FIG. 2.

Although not shown, assume that node S4 16d supported a service different than that supported by nodes S1 16a, S2 16b and S5 16e via UNI 18. A failure on the link between node S1 16a and S4 16d would not affect the service available via UNI 18 but might affect service and access if a sub-domain used the link between node S1 16a and S4 16d as its primary link. In such a case, the sub-domain supporting the service on S4 16d would see a state change in the primary SDMA and would need to switch to the backup SDMA, perhaps using a route via node S3 16c and S5 16e. In this case, the service on one SDMA is not impacted while the other service available using the other SDMA is impacted. Advantageously, since monitoring and switching is being done at the sub-domain level in accordance with the present invention, changes affecting services can be granularized and the resultant impact minimized on the best of the broadcast domain.

According to another aspect of the invention, when SDMA MEPs are located at a edge node 16 supporting an NNI (not shown), the protection switching from the primary path to backup path may involve switching of the incoming traffic's VLAN, which can be the VLAN corresponding to the primary path within the sub-domain, to a backup VLAN corresponding to the backup path, when primary SDMA is detected to be down and a switching to backup SDMA is needed. Similarly, upon egress of traffic from a sub-domain across an edge node 16 supporting a NNI, a similar switching may be performed to restore the value of VLAN to its original value outside the sub-domain. This allows for the sub-domain protection to be transparent to the entities outside the sub-domain. Switching the traffic incoming on an edge node 16 on a UNI 18 interface, remains the same across the primary and backup paths within the sub-domain, since generally incoming traffic frames are encapsulated in the same manner across primary or backup path in a edge node 16 across UNI 18 interface and outgoing traffic frames are de-encapsulated in the same manner from primary or backup path in an edge node 16 across UNI 18 interface.

Sub-domain protection in accordance with the present invention provides the ability to protect a number of services that share common nodes within a large broadcast domain. This sub-domain protection arrangement provides a protection solution for services that require use of multi-point topology. The collective state of the point to point path between the nodes within a sub-domain determines the state of the sub-domain. In accordance with the present invention, primary and backup sub-domain is used to provide the protection mechanism for the services within the sub-domain. The states of the primary and backup sub-domains drive the protection switching for services that are transported by the primary and backup sub-domains. As discussed above in detail, the present invention provides a sub-domain protection group to which the primary and backup sub-domains are associated and tracked.

Advantageously, each sub-domain does not require dedicated protection messaging resources, i.e., CCMs. The sub-domain maintenance association groups include RMEP resources that are used to determine the state of sub-domain. An RMEP can be associated with multiple SDMAs, de-coupling MEP and RMEP resources from the protection mechanism providing a scalable and implementable solution.

The present invention can be realized in hardware, software, or a combination of hardware and software. An implementation of the method and system of the present invention can be realized in a centralized fashion in one computing system, or in a distributed fashion where different elements are spread across several interconnected computing systems. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system and/or components within the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A method for protecting a service available on a broadcast domain, the method comprising:
establishing a sub-domain within the broadcast domain, the sub-domain including a group of nodes used to provide a communication path to the service;
monitoring a primary sub-domain maintenance association and a back-up sub-domain maintenance association, the primary and back-up sub-domain maintenance associations being a set of primary and back-up paths, respectively, representing connectivity between nodes acting as edge nodes in the sub-domain;
detecting a fault within the primary sub-domain maintenance association; and
switching to the back-up sub-domain maintenance association.

2. The method of claim 1, wherein the sub-domain is established based on a physical relationship between the group of nodes.

3. The method of claim 1, wherein the sub-domain is established based on a logical relationship between the group of nodes such that access to a service is self-contained within the sub-domain.

4. The method of claim 1, further comprising switching packet routing from a primary sub-domain corresponding to the primary sub-domain maintenance association to a sub-domain corresponding to the back-up sub-domain maintenance association when a failure occurs on at least one of a link and a node on a path within the primary sub-domain maintenance association.

5. The method of claim 4, further comprising associating services to be managed with a sub-domain protection group, wherein the switching is managed using the sub-domain protection group.

6. The method of claim 1, further comprising associating one or more remote node end points (“RMEPs”) with the primary and back-up sub-domain maintenance associations, wherein a state of communication with the RMEPs is monitored to detect the fault within the primary sub-domain maintenance association.

7. The method of claim 6, wherein the state of communications with the one or more RMEPs is monitored using unicast continuity check messages.

8. The method of claim 6, wherein the state of communications with the one or more RMEPs are monitored using multicast and unicast continuity check messages indicating remote defect identification (“RDI”), the unicast messages indicating RDI being sent to an RMEP having a detected communications failure.

9. The method of claim 6, wherein the state of communications with the one or more RMEPs are monitored using multicast continuity check messages, at least a portion of the multicast continuity check messages indicating remote defect identification (“RDI”), the multicast messages indicating RDI and including a list of RMEP having a detected communications failure.

10. The method of claim 1, further including monitoring the domain maintenance association, wherein monitoring the domain maintenance association and monitoring the primary and back-up sub-domain maintenance associations are performed by a same set of MEPs.

11. The method of claim 1, further including monitoring the domain maintenance association, wherein monitoring the domain maintenance association and monitoring the primary and back-up sub-domain maintenance associations are performed by a first set and a second set of MEPs, respectively.

12. The method of claim 11, wherein monitoring of the domain maintenance association is performed at a first rate and monitoring of the primary and back-up sub-domain maintenance associations are performed at a second rate, the second rate being faster than the first rate.

13. The method of claim 1, wherein switching to the back-up sub-domain maintenance association includes switching traffic between a primary path and a back-up path across a sub-domain NNI interface by switching an incoming VLAN to an active VLAN path value and restoring the VLAN value upon egress from the sub-domain.

14. A system for providing a service available on a broadcast domain, the system comprising:
a plurality of nodes, the plurality of nodes being arranged as a sub-domain which provide a communication path to the service, each of the nodes including:
a storage device arranged to store data corresponding to a primary sub-domain maintenance association and a back-up sub-domain maintenance association, the primary and back-up sub-domain maintenance associations being a set of primary and back-up paths, respectively, representing connectivity between nodes acting as edge nodes in the sub-domain; and
a central processing unit, the central processing unit operating to:
detect a fault within the primary sub-domain maintenance association; and
switch to the back-up sub-domain maintenance association.

15. The system of claim 14, wherein the sub-domain is based on a physical relationship between the group of nodes.

16. The system of claim 14, wherein the sub-domain is based on a logical relationship between the group of nodes such that access to a service is self-contained within the sub-domain.

17. The system of claim 14, wherein the central processing unit further switches packet routing from a primary sub-domain corresponding to the primary sub-domain maintenance association to a sub-domain corresponding to the back-up sub-domain maintenance association when a failure occurs on at least one of a link and a node on a path within the primary sub-domain maintenance association.

18. The system of claim 17, services to be managed and the sub-domain maintenance associations are associated with a sub-domain protection group, wherein the switching is managed based on a state of the sub-domain maintenance associations.

19. The system of claim 14, further comprising associating one or more remote node end points (“RMEPs”) with the primary and back-up sub-domain maintenance associations, wherein a state of communication with the RMEPs is monitored by the central processing unit to detect the fault within the primary sub-domain maintenance association.

20. The system of claim 19, wherein the state of communications with the one or more RMEPs is monitored using unicast continuity check messages.

21. The system of claim 19, wherein the state of communications with the one or more RMEPs are monitored using multicast and unicast continuity check messages indicating remote defect identification (“RDI”), the unicast messages indicating RDI being sent to an RMEP having a detected communications failure.

22. The system of claim 19, wherein the state of communications with the one or more RMEPs are monitored using multicast continuity check messages, at least a portion of the multicast continuity check messages indicating remote defect identification (“RDI”), the multicast messages indicating RDI and including a list of RMEP having a detected communications failure.

23. A storage medium storing a computer program which when executed performs method for protecting a service available on a broadcast domain, the method comprising:
establishing a sub-domain within the broadcast domain, the sub-domain including a group of nodes used to provide a communication path to the service;
monitoring a primary sub-domain maintenance association and a back-up sub-domain maintenance association, the primary and back-up sub-domain maintenance associations being a set of primary and back-up paths, respectively, representing connectivity between nodes acting as edge nodes in the sub-domain;
detecting a fault within the primary sub-domain maintenance association; and
switching to the back-up sub-domain maintenance association.

24. The method of claim 23, further comprising switching packet routing from a primary sub-domain corresponding to the primary sub-domain maintenance association to a sub-domain corresponding to the back-up sub-domain maintenance association when a failure occurs on at least one of a link and a node on a link on a path within the primary sub-domain maintenance association.

25. The method of claim 24, further comprising associating services to be managed with a sub-domain protection group, wherein the switching is managed using the sub-domain protection group.

26. The method of claim 23, further comprising associating one or more remote node end points (“RMEPs”) with the primary and back-up sub-domain maintenance associations, wherein a state of communication with the RMEPs is monitored to detect the fault within the primary sub-domain maintenance association.
